(19) United States
(12) Patent Application Publication
(10) Pub. No.: US 2023/0176958 A1
(43) Pub. Date: Jun. 8, 2023

(54) MONITORING CODE COVERAGE

(71) Applicant: International Business Machines Corporation, Armonk, NY (US)

(72) Inventors: Nitish Jindal, Bangalore (IN); Anay K Desai, Bengaluru (IN); Gregory Scott Still, Raleigh, NC (US); Michael Stephen Floyd, Cedar Park, TX (US)

(21) Appl. No.: 17/541,326

(22) Filed: Dec. 3, 2021

(51) Int. Cl. G06F 11/36

(52) U.S. Cl. CPC G06F 11/3676; G06F 11/3612; G06F 11/3636

(57) ABSTRACT

Aspects of the invention include monitoring code coverage by executing a code sequence having a plurality of embedded markers. Aspects also include transmitting, upon encountering one of the plurality of embedded markers, a probing signal corresponding to the one of the plurality of embedded markers. Aspects further include obtaining, by a programmable data recorder, a debug level for the execution of the code sequence. Aspects also include storing the probing signal in a trace array based on a determination, by a programmable data recorder based on the debug level, that the probing signal should be recorded.

### STATEMENT REGARDING PRIOR DISCLOSURES BY THE INVENTORS

The following disclosure(s) are submitted under 35 U.S.C. 102(b)(1)(A) as prior disclosures by, or on behalf of, a sole inventor of the present application or a joint inventor of the present application:

Product Release Announcement titled, “IBM unveils new generation of IBM Power servers for frictionless, scalable hybrid cloud”, for a product, IBM Power E1080 server, made publicly available on Sep. 8, 2021.

### BACKGROUND

The present invention generally relates to monitoring code coverage, and more specifically, to a hardware performance tool to monitor code coverage.

In analyzing and enhancing the performance of a data processing system and the applications executing within the data processing system, it is helpful to know which software modules within a data processing system are using system resources. In general, performance tools are used to monitor and examine a data processing system to determine resource consumption as various software applications are executing within the data processing system. These performance tools are generally categorized as either hardware performance tools, which are embedded in a processing system, and software performance tools.

### SUMMARY

Embodiments of the present invention are directed to a computer-implemented method for monitoring code coverage. A non-limiting example of the computer-implemented method includes executing, by a processing device, a code sequence having a plurality of embedded markers. The method also includes transmitting, by the processing device upon encountering one of the plurality of embedded markers, a probing signal corresponding to the one of the plurality of embedded markers. The method further includes obtaining, by a programmable data recorder, a debug level for the execution of the code sequence. The method also includes storing the probing signal in a trace array, based on a determination, by a programmable data recorder based on the debug level, that the probing signal should be recorded.

Embodiments of the present invention are directed to a system for monitoring code coverage. A non-limiting example of the system includes a processor communicative coupled to a memory, the processor operable to execute a code sequence having a plurality of embedded markers. The processor also operable to transmit, upon encountering one of the plurality of embedded markers, a probing signal corresponding to the one of the plurality of embedded markers. The processor further operable to obtain, by a programmable data recorder, a debug level for the execution of the code sequence. The processor also operable to store the probing signal in a trace array, based on a determination, by a programmable data recorder based on the debug level, that the probing signal should be recorded.

Embodiments of the invention are directed to a computer program product for monitoring code coverage, the computer program product comprising a computer readable storage medium having program instructions embodied therewith. The program instructions are executable by a processor to cause the processor to perform a method. A non-limiting example of the method includes executing, by a processing device, a code sequence having a plurality of embedded markers. The method also includes transmitting, by the processing device upon encountering one of the plurality of embedded markers, a probing signal corresponding to the one of the plurality of embedded markers. The method further includes obtaining, by a programmable data recorder, a debug level for the execution of the code sequence. The method also includes storing the probing signal in a trace array, based on a determination, by a programmable data recorder based on the debug level, that the probing signal should be recorded.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a computer system for use in implementing one or more embodiments of the present invention;

FIG. 2 depicts a system for monitoring code coverage according to embodiments of the invention;

FIG. 3 depicts a flow diagram of a method for monitoring code coverage according to one or more embodiments of the invention; and

FIG. 4 depicts a flow diagram of another method for monitoring code coverage according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

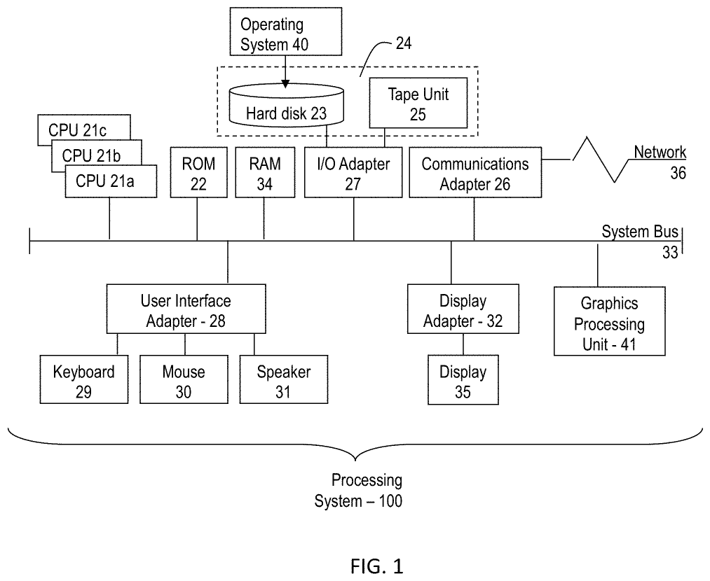

Referring to FIG. 1, there is shown an embodiment of a processing system 100 for implementing the teachings herein. In this embodiment, the system 100 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 100.

FIG. 1 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 100 may be stored in mass storage 24. A network adapter 26 interconnects bus 33 with an outside network 36 enabling data processing system 100 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 100 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 1, the system 100 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system to coordinate the functions of the various components shown in FIG. 1.

Turning now to an overview of the aspects of the invention, one or more embodiments of the invention provide for monitoring code coverage. In general, performance tools are used to monitor the code coverage of a software product, i.e., what parts of the software are executed during the execution o the software product. Exemplary embodiments include a hardware performance tool that monitors the code coverage of a software product, also referred to herein as a code sequence. In exemplary embodiments, markers are embedded into the code sequence and an association is created between each marker and its location in the code sequence. For example, a given marker can be associated with a particular instruction or subroutine of the code sequence. During the execution of the code sequence, when a marker is encountered by a processor, a probing signal associated marker is generated and recorded into a trace array, which functions as a log. Once the execution of the code sequence is complete, a review and analysis of the trace log identify which portions of the code sequence were executed.

In cases where the capacity of the trace log is limited, during the execution of a code sequence the trace array can be overflowed unless measures are taken to reduce the amount of data written to the trace array. Accordingly, in exemplary embodiments, a debug level is used to determine what data to store in the trace array. In one embodiment, the debug level specifies which probing signals are monitored and recorded in the trace array. As a result, a user can control which aspects of the code coverage are monitored by making changes to the debug level applied during the execution of the code sequence.

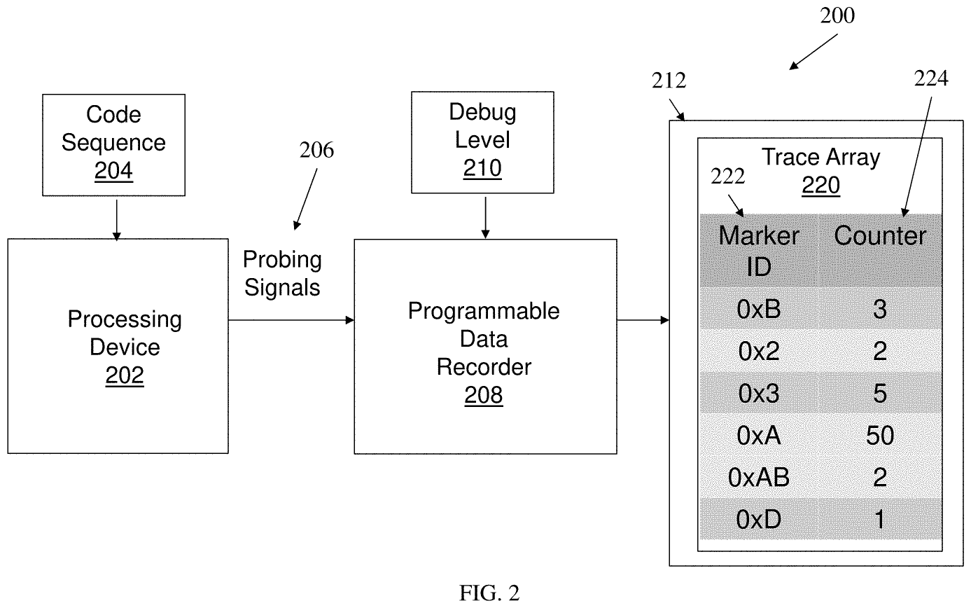

Turning now to a more detailed description of aspects of the present invention, FIG. 2 depicts a system 200 for monitoring code coverage according to embodiments of the invention. System 200 includes a processing device 202, a programable data recorder 208, and a memory device 212. In one or more embodiments of the invention, the processing device 202, the programable data recorder 208 and the memory device 212 can be implemented on the processing system 100 found in FIG. 1.

As illustrated, the processing device 202 receives a code sequence 204, which includes a plurality of markers. During the execution of the code sequence 204 by processing device 202, processing device 202 transmits a probing signal 206 upon encountering a marker. The probing signals 206 transmitted by the processing device 202 identify which marker has been encountered. The programable data recorder 208 is configured to receive the probing signals 206 from the processing device 202 and obtain a debug level 210. In exemplary embodiments, the debug level 210 is used by the programable data recorder 208 to determine what data to write to the trace array 220 upon receiving the probing signals 206.

In one embodiment, the debug level 210 specifies a subset of the probing signals 206 that should be ignored and a subset of the probing signals that should result in data being written to the trace array. In exemplary embodiments, the debug level 210 may also specify one or more thresholds associated with one or more of the probing signals 206. For example, the debug level 210 may indicate to record data for a number of occurrences of a probing signal 206 below a first threshold level, i.e., only record data for the first n number of instances of a given probing signal 206 in the trace array 220.

In exemplary embodiments, the trace array 220 is stored in a memory device 212 and includes a marker identification 222 that stores an identification of the marker that corresponds to the probing signal 206. In one embodiment, the trace array 220 consists of only a list of marker identifications 222 that are disposed in the order in which the probing signals were transmitted by the processing device 202 and stored in the trace array 220. In another embodiment, the trace array 220 includes a marker identification 222 and a counter 224 associated with each marker identification 222, which is used to store a number of times a probing signal associated with a marker identification 222 was transmitted by the processing device 202.

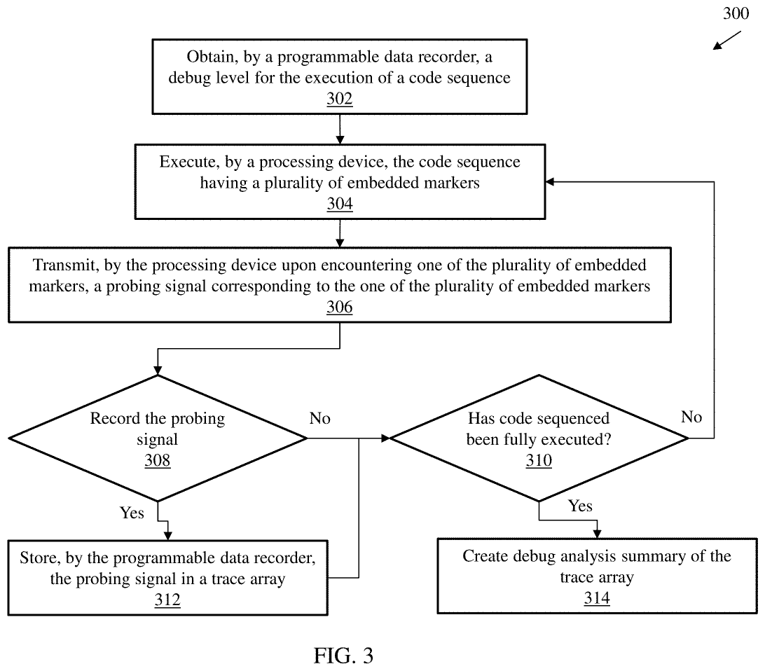

Referring now to FIG. 3, a flow diagram of a method for monitoring code coverage according to one or more embodiments of the invention is shown. The method 300 includes obtaining, by a programmable data recorder, a debug level for the execution of a code sequence, as shown at block 302. Next, as shown at block 304, the method 300 includes executing, by a processing device, the code sequence having a plurality of embedded markers. In exemplary embodiments, each of the plurality of embedded markers are associated with a portion of the code sequence. In one embodiment, each of the plurality of embedded markers are unique. The method 300 also includes transmitting, by the processing device upon encountering one of the plurality of embedded markers, a probing signal corresponding to the one of the plurality of embedded markers, as shown at block 306.

Next, as shown at decision block 308, the method 300 includes determining whether to record the probing signal. In exemplary embodiments, the determination of whether to record the probing signal is based on the debug level. Based on deciding that the probing signal should be recorded, the method 300 proceeds to block 312 and includes storing, by the programmable data recorder, the probing signal in a trace array. Otherwise, the method 300 proceeds to decision block 310 and determines if the code sequence has been fully executed. If the code sequence has not been fully executed, the method 300 returns to block 304. Otherwise, the method 300 proceeds to block 314 and creates a debug analysis summary of the trace array.

In exemplary embodiments, the debug analysis summary is created based at least in part on the debug level. In one embodiment, the debug level includes an indication of an expected occurrence level for the probing signal corresponding to each of the plurality of embedded markers in the trace array, and the analysis summary includes a comparison of the expected occurrence level for the probing signal and an actual occurrence level for the probing signal in the trace array. In one embodiment, the expected occurrence levels include a low occurrence level that includes a number of occurrences below a first threshold level, an average occurrence level that includes a number of occurrences above the first threshold level and below a second threshold level, and a high occurrence level that includes a number of occurrence above the second threshold level. In exemplary embodiments, the debug analysis summary further includes an indication of any probing signals that were not recorded in the trace array.

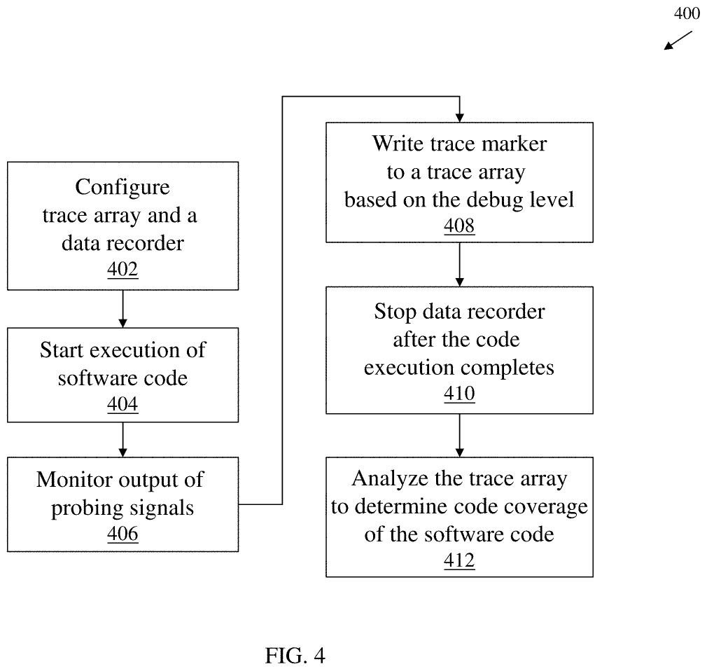

Referring now to FIG. 4, a flow diagram of another method 400 for monitoring code coverage according to one or more embodiments of the invention is shown. The method 400 includes configuring a trace array and a data recorder, as shown at block 402. In exemplary embodiments, configuring the data recorder includes obtaining a debug level to be applied. Next, as shown at block 404, the method 400 includes starting the execution of a software code having a plurality of embedded markers. As block 406, the method 400 also includes monitoring the output of probing signals, which are generated each time a marker is encountered during the execution of the software code. The method 400 further includes writing a trace maker to the trace array based on the debug level, as shown at block 408. Next, as shown at block 410, the method 400 includes stopping the data recorder aft the code execution completes. The method 400 concludes at block 412 by analyzing the trace array to determine the code coverage of the software code. The analysis provides insight into the order in which, and the frequency that, particular code sections are executed.

Additional processes may also be included. It should be understood that the processes depicted in FIGS. 3 and 4 represent illustrations, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A method for monitoring code coverage, the method comprising:
executing, by a processing device, a code sequence having a plurality of embedded markers;
transmitting, by the processing device upon encountering one of the plurality of embedded markers, a probing signal corresponding to the one of the plurality of embedded markers;
obtaining, by a programmable data recorder, a debug level for the execution of the code sequence;
based on a determination, by the programmable data recorder based on the debug level, that the probing signal should be recorded, storing the probing signal in a trace array; and
based on a determination, by the processing device, that the execution of the code sequence has been completed, creating a debug analysis summary of the trace array, wherein the analysis summary is based at least in part on the debug level,
wherein the debug level includes an indication of an expected occurrence level for the probing signal corresponding to each of the plurality of embedded markers in the trace array and wherein the analysis summary includes a comparison of the expected occurrence level for the probing signal and an actual occurrence level for the probing signal in the trace array.

2. The method of claim 1, wherein each of the plurality of embedded markers are associated with a portion of the code sequence.

3. The method of claim 2, wherein each of the plurality of embedded markers are unique.

4. The method of claim 1, wherein the debug level includes an indication of whether to record the probing signal corresponding to each of the plurality of embedded markers in the trace array.

5. (canceled)

6. (canceled)

7. The method of claim 1, further comprising:
based on a determination, by a programmable data recorder based on the debug level, that the trace array includes an entry corresponding to the probing signal, incrementing a counter for the probing signal in the trace array.

8. A system comprising:
a processor communicatively coupled to a memory, the processor configured to:
execute a code sequence having a plurality of embedded markers;
transmit, upon encountering one of the plurality of embedded markers, a probing signal corresponding to the one of the plurality of embedded markers;
obtain, by a programmable data recorder, a debug level for the execution of the code sequence; and
based on a determination, by the programmable data recorder based on the debug level, that the probing signal should be recorded, store the probing signal in a trace array; and
based on a determination, by the processing device, that the execution of the code sequence has been completed, create a debug analysis summary of the trace array, wherein the analysis summary is based at least in part on the debug level,
wherein the debug level includes an indication of an expected occurrence level for the probing signal corresponding to each of the plurality of embedded markers in the trace array and wherein the analysis summary includes a comparison of the expected occurrence level for the probing signal and an actual occurrence level for the probing signal in the trace array.

9. The system of claim 8, wherein each of the plurality of embedded markers are associated with a portion of the code sequence.

10. The system of claim 9, wherein each of the plurality of embedded markers are unique.

11. The system of claim 8, wherein the debug level includes an indication of whether to record the probing signal corresponding to each of the plurality of embedded markers in the trace array.

12. (canceled)

13. (canceled)

14. The system of claim 8, wherein the processor is further configured to:
based on a determination, by a programmable data recorder based on the debug level, that the trace array includes an entry corresponding to the probing signal, incrementing a counter for the probing signal in the trace array.

15. A computer program product comprising a computer readable storage medium having program instructions embodied therewith, the program instructions executable by a processor to cause the processor to perform a method comprising:
executing a code sequence having a plurality of embedded markers;
transmitting, upon encountering one of the plurality of embedded markers, a probing signal corresponding to the one of the plurality of embedded markers;
obtaining, by a programmable data recorder, a debug level for the execution of the code sequence; and
based on a determination, by the programmable data recorder based on the debug level, that the probing signal should be recorded, storing the probing signal in a trace array; and
based on a determination, by the processing device, that the execution of the code sequence has been completed, creating a debug analysis summary of the trace array, wherein the analysis summary is based at least in part on the debug level,
wherein the debug level includes an indication of an expected occurrence level for the probing signal corresponding to each of the plurality of embedded markers in the trace array and wherein the analysis summary includes a comparison of the expected occurrence level for the probing signal and an actual occurrence level for the probing signal in the trace array.

16. The computer program product of claim 15, wherein each of the plurality of embedded markers are associated with a portion of the code sequence.

17. The computer program product of claim 16, wherein each of the plurality of embedded markers are unique.

18. The computer program product of claim 15, wherein the debug level includes an indication of whether to record the probing signal corresponding to each of the plurality of embedded markers in the trace array.

19. (canceled)

20. (canceled)
